(19) United States
(12) Patent Application Publication
(10) Pub. No.: US 2025/0324297 A1
(43) Pub. Date: Oct. 16, 2025

(54) APPROACHES FOR WIRELESS SENSING

(71) Applicant: Telefonaktiebolaget LM Ericsson (publ), Stockholm (SE)

(72) Inventors: Leif WILHELMSSON, Lund (SE); Maxime BOUTON, Stockholm (SE); Athanasios STAVRIDIS, Malmö (SE); Pontus ARVIDSON, Sollentuna (SE)

(21) Appl. No.: 18/870,128

(22) PCT Filed: Nov. 30, 2022
(86) PCT No.: PCT/EP2022/083859

§ 371 Date: Nov. 27, 2024

(30) Foreign Application Priority Data
Jun. 3, 2022 (GR) 20220100469

(51) Int. Cl. H04W 24/08

(52) U.S. Cl. CPC H04W 24/08

(57) ABSTRACT

A method is disclosed for controlling wireless sensing when opportunistic sensing is available for providing a first set of sensing measurements, wherein the opportunistic sensing comprises sensing measurements on packets transmitted for other purposes than wireless sensing. When the first set of sensing measurements provided by opportunistic sensing is insufficient for determination of a sensing result a session of dedicated sensing for providing a second set of sensing measurements is triggered. Opportunistic sensing includes sensing measurements on packets transmitted for other purposes than wireless sensing, and dedicated sensing comprises sensing measurements on one or more sensing packets transmitted specifically for wireless sensing. Corresponding computer program product, apparatus, and sensing control node are also disclosed.

### TECHNICAL FIELD

The present disclosure relates generally to the field of wireless sensing.

### BACKGROUND

A purpose of wireless sensing—also referred to herein as sensing—is to detect physical changes in an environment (e.g., movement of persons or objects). There are a number of possible applications for wireless sensing, including home security (e.g., intruder detection, burglar alarm), control of home appliances (e.g., smart lighting), and health care (e.g., monitoring vital signs such as heart rate, breathing, etc.).

Wireless sensing is a useful enhancement for radio technologies that have been designed primarily for communications. For example, wireless sensing can be performed by letting devices, that are compliant with the specification requirements for an IEEE 802.11 station (STA), act as sensing transmitter and sensing receiver to detect changes in a wireless propagation channel between the devices.

Generally, IEEE 802.11 stations are classified into Access Point Stations (AP STAs) and non-Access Point Stations (non-AP STAs); sometimes simply referred to as APs and STAs, respectively.

A sensing receiver typically receives multiple physical layer packets transmitted by a sensing transmitter, and performs sensing measurements on each of the packets. The sensing measurements are used to detect changes in the wireless propagation channel. Detected changes are interpreted as occurrence of events and the events may be classified based on the nature of the detected changes.

A problem in the context of wireless sensing is that the packets used for sensing entail signaling overhead, which may reduce throughput for the communication system in which the wireless sensing is performed. Some sensing applications require a huge amount of packets for sensing, which makes the signaling overhead problem severe.

Therefore, there is a need for alternative approaches to wireless sensing. Preferably, such approaches provide adequate sensing with moderate signaling overhead.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

A first aspect is a method for controlling wireless sensing when opportunistic sensing is available for providing a first set of sensing measurements, wherein the opportunistic sensing comprises sensing measurements on packets transmitted for other purposes than wireless sensing. The method comprises, when the first set of sensing measurements provided by opportunistic sensing is insufficient for determination of a sensing result, triggering a session of dedicated sensing for providing a second set of sensing measurements. Dedicated sensing comprises sensing measurements on one or more sensing packets transmitted specifically for wireless sensing.

In some embodiments, the method further comprises determining the sensing result based on a combination of the first set of sensing measurements provided by opportunistic sensing and the second set of sensing measurements provided by dedicated sensing.

In some embodiments, the method further comprises, when the first set of sensing measurements provided by opportunistic sensing is sufficient for determination of the sensing result, determining the sensing result based only on the first set of sensing measurements provided by opportunistic sensing.

In some embodiments, the method further comprises evaluating the first set of sensing measurements provided by opportunistic sensing at a first moment in time. The first moment in time occurs before a second moment in time, and the sensing result is required to be determined at the second moment in time.

In some embodiments, a time interval between the first moment in time and the second moment in time is configured to accommodate the session of dedicated sensing.

In some embodiments, the method further comprises, when the first set of sensing measurements provided by opportunistic sensing combined with the second set of sensing measurements provided by dedicated sensing is insufficient for determination of the sensing result, continuing the session of dedicated sensing.

In some embodiments, the method further comprises, when the first set of sensing measurements provided by opportunistic sensing combined with the second set of sensing measurements provided by dedicated sensing is sufficient for determination of the sensing result, terminating the session of dedicated sensing.

In some embodiments, the sensing result is required to be determined in relation to one or more required locations, each sensing measurement is associated with a sensed location, and sensing measurements are insufficient for determination of the sensing result when—for at least one required location—the required location is comprised in the sensed location for a number of sensing measurements which is lower than a threshold value.

In some embodiments, the sensed location associated with a particular sensing measurement is defined by a transmitter identity associated with the sensing measurement.

In some embodiments, the sensed location associated with a particular sensing measurement is defined by a beamforming associated with the sensing measurement.

In some embodiments, the sensed location associated with a particular sensing measurement is defined by a transmission power associated with the sensing measurement.

In some embodiments, the method further comprises, when the sensing measurements are insufficient for determination of the sensing result, selecting a sensing transmitter for a next sensing packet to be transmitted specifically for wireless sensing.

In some embodiments, the method further comprises determining a score for each of a plurality of possible sensing transmitters, wherein the score is indicative of a potential sensing measurement gain associated with further dedicated sensing, and wherein the sensing transmitter is selected from the plurality of possible sensing transmitters based on the determined scores.

In some embodiments, a machine learning model is used to control the session of dedicated sensing.

In some embodiments, the machine learning model—for each packet utilized for sensing measurements—receives respective sensing measurement indications and associated locations for each of one or more sensing receivers.

In some embodiments, the machine learning model has a hidden state for each of the one or more sensing receivers, and the hidden state is updated for each packet utilized for sensing measurements.

In some embodiments, the machine learning model selects the sensing transmitter based on the sensing measurement indications.

In some embodiments, the machine learning model comprises one or more probability estimators and a determiner. Each probability estimator is configured to receive the respective sensing measurement indications for at least one associated location and provide a respective output. The determiner is configured to—based on the respective output from the one or more probability estimators—determine whether further dedicated sensing is to be performed and/or select sensing transmitter for further dedicated sensing.

A second aspect is a computer program product comprising a non-transitory computer readable medium, having thereon a computer program comprising program instructions. The computer program is loadable into a data processing unit and configured to cause execution of the method according to the first aspect when the computer program is run by the data processing unit.

A third aspect is an apparatus for controlling wireless sensing when opportunistic sensing is available for providing a first set of sensing measurements, wherein the opportunistic sensing comprises sensing measurements on packets transmitted for other purposes than wireless sensing. The apparatus comprises controlling circuitry. The controlling circuitry is configured to cause, responsive to the first set of sensing measurements provided by opportunistic sensing being insufficient for determination of a sensing result, triggering of a session of dedicated sensing for provision of a second set of sensing measurements, wherein the dedicated sensing comprises sensing measurements on one or more sensing packets transmitted specifically for wireless sensing.

A fourth aspect is a sensing control node comprising the apparatus of the third aspect.

In some embodiments, any of the above aspects may additionally have features identical with or corresponding to any of the various features as explained above for any of the other aspects.

Generally, a collection (e.g., one or more sets) of sensing measurements may be determined as sufficient for determination of a sensing result when the collection comprises a sufficient number (e.g., at least two, or some other suitable threshold value) of sensing measurements for each location to be sensed; and may be determined as insufficient for determination of a sensing result otherwise (i.e., when the collection comprises less than the sufficient number of sensing measurements for at least one location to be sensed). Typically, there is not determined/provided any sensing result when the available sensing measurements (e.g., the first set of sensing measurements provided by opportunistic sensing, possibly combined with the second set of sensing measurements provided by dedicated sensing) are determined as insufficient for determination of a sensing result.

Also generally, it should be noted that a set of sensing measurements (e.g., the first set of sensing measurements and/or the second set of sensing measurements) may be an empty set, or a set with only one sensing measurement, or a set with two or more sensing measurements.

An advantage of some embodiments is that alternative approaches to wireless sensing are provided.

An advantage of some embodiments is that approaches to wireless sensing are provided that provide adequate sensing (e.g., in a more efficient way than according to other approaches to wireless sensing). For example, requirements for adequate sensing may comprise one or more of: sensing accuracy (e.g., in terms of false detection rate and/or probability of miss), sensing latency (e.g., in terms of delay between a physical change in environment and corresponding detection of event occurrence), and coverage (e.g., in terms of physical area/space for movement detection).

An advantage of some embodiments is that approaches to wireless sensing are provided that entail moderate signaling overhead. For example, requirements for moderate overhead may comprise one or more of: the signaling overhead being less than a signaling overhead threshold value, and the signaling overhead being less than that of other sensing approaches. This advantage may be referred to as the wireless sensing being efficient.

An advantage of some embodiments is that the throughput for the communication system in which the wireless sensing is performed may be increased compared to other sensing approaches.

Some embodiments enable accurate sensing to be performed with a smaller number of dedicated sensing packets compared to other sensing approaches. Consequently, there are more radio resources available for sending ordinary data and/or control packets, and the overall data throughput can be increased compared to situations where other sensing approaches are used. Alternatively or additionally, the radio resources made available by use of opportunistic sensing may be used for dedicated sensing packets to provide enhanced sensing performance compared to what is achievable by other sensing approaches with the same amount of dedicated sensing packets.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a schematic drawing illustrating an example scenario for wireless sensing according to some embodiments;

FIG. 2 is a flowchart illustrating example method steps according to some embodiments;

FIG. 3 is a schematic block diagram illustrating an example machine learning model according to some embodiments;

FIG. 4 is a plot illustrating example probability estimates according to some embodiments;

FIG. 5 is a schematic block diagram illustrating an example apparatus according to some embodiments; and

FIG. 6 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

As already mentioned, wireless sensing can be applied to detect physical changes in an environment, which is typically accomplished by detecting changes in a wireless propagation channel. Detection of propagation channel changes typically involves that a sensing communication device performs sensing measurements on two or more packets (e.g., packets transmitted from the same transmitting communication device), and compares the measurement results, to detect (and possibly classify) event occurrence. Each packet used for sensing measurements is typically a physical layer packet.

Some examples of sensing measurements include Received Signal Strength Indicator (RSSI) measurements, Channel State Information (CSI) measurements, and measurements of time and/or frequency response of the propagation channel.

Generally, a communication device that transmits packets that are used for sensing measurements is called a sensing transmitter, while a communication device that performs sensing measurements is called a sensing receiver.

It should be noted that, while sensing measurements are performed by a sensing receiver, the processing of the sensing measurements (e.g., to detect changes in the wireless propagation channel) may be performed by the sensing receiver that performed the measurements, or by any other suitable device to which the sensing measurements are provided by the sensing receiver. Furthermore, the sensing results (e.g., events indicating physical changes) may be used by the device that processes the sensing measurements, or by any other suitable device to which the sensing results are provided by the device that processes the sensing measurements.

A problem in the context of wireless sensing is that the packets used for sensing entail signaling overhead, which may reduce throughput for the communication system in which the wireless sensing is performed. Some sensing applications require a huge amount of packets for sensing, which makes the signaling overhead problem severe. Thus, sending packets for the sole purpose of enabling sensing is, in some sense, wasteful.

Therefore, it may be beneficial to perform sensing measurements on packets that are sent anyway (i.e., for other purposes than sensing), for example, data packets and control packets. A potential problem with this approach is that there may not be enough packets available for accurate sensing. Particularly, since the packets are only sent when there actually is something that needs to be conveyed (e.g., data/control), the opportunities for performing corresponding sensing measurements will typically be less predictable than when packets specifically intended for sensing are used.

Alternatively or additionally, it may be beneficial to let two or more sensing receivers perform sensing measurements on a same packet.

Thus, each packet used for sensing may be a dedicated sensing packet transmitted by a sensing transmitter (dedicated sensing), or a packet—e.g., a data packet or a control packet—transmitted for other purposes than sensing (opportunistic sensing). In the following, approaches for combining opportunistic sensing with dedicated sensing will be described. According to some embodiments, such combination provides accurate, yet efficient, sensing.

Some embodiments are particularly relevant in the context of systems and devices compliant with IEEE 802.11 standardization specifications.

Up until IEEE 802.11n, there was little difference between an AP and a STA regarding channel access and packet appearance on the channel. Specifically, each packet was sent from a single transmitter (AP or STA) and intended for a single receiver (STA or AP). With IEEE 802.11ac, multi-user (MU) multiple-input multiple-output (MIMO) transmission was introduced for the downlink (DL), implying that a DL packet could be sent from one transmitter (AP) and be intended for many receivers (STAs). Furthermore, IEEE 802.11ax supports orthogonal frequency division multiple access (OFDMA) in both DL and UL; e.g., the AP can receive UL transmissions from up to nine STAs in a 20 MHz channel.

FIG. 1 schematically illustrates an example scenario for wireless sensing according to some embodiments.

The scenario of FIG. 1 relates to a physical area/space 100 (e.g., a room), within which the sensing is performed. Depending on the application, sensing may be required for the entire space 100, or for only one or more part(s) of the space 100. For example, when the sensing is applied for intruder detection and the sensing result should indicate whether or not an intrusion is detected, it may be sufficient (or at least most important) for provision of the sensing result to detect movement for parts of the space 100 that is in vicinity of possible entrances into the space 200 (e.g., doors, windows, etc.).

The scenario of FIG. 1 has an access point (AP) 110 and a plurality of stations (STA) 121, 122, 123, 124, 125, 126. Also illustrated are a number of wireless propagation channels between various pairs of devices. Particularly, 151, 152, 153, 154, 155, 156 represent wireless propagation channels between the AP 110 and the STAs 121, 122, 123, 124, 125, 126, respectively; 161 represents a wireless propagation channel between the STAs 125 and 126; 162 represents a wireless propagation channel between the STAs 121 and 122; 163 represents a wireless propagation channel between the STAs 122 and 123; and 164 represents a wireless propagation channel between the STAs 121 and 123.

It should be noted that each of the wireless propagation channels is schematically represented by a single line-of-sight (LoS) path, while an actual wireless propagation channel can be much more complex (e.g., with several paths; with or without a LoS path). For example, when there is a LoS path (or another dominant path), the signal components coming from additional paths can be expected to be much weaker than the signal component coming from the LoS/dominant path. Thus, changes in the propagation channel portions relating to the additional paths are not easily detected, and it can be assumed that detected changes in the propagation channel relate to physical movements in a location if the LoS/dominant path. This phenomenon is particularly prominent for directional (e.g., beam-formed) transmission.

Wireless sensing may be performed by letting the AP 110 act as sensing transmitter and letting one or more of the STAs 121, 122, 123, 124, 125, 126 act as sensing receivers. Alternatively or additionally, wireless sensing may be performed by letting one of the STAs 121, 122, 123, 124, 125, 126 act as sensing transmitter and letting the AP 110 act as sensing receiver. These approaches enable detection of changes in the wireless propagation channels between the AP 110 and the respective STA 121, 122, 123, 124, 125, 126, i.e., changes in the wireless propagation channels 151, 152, 153, 154, 155, 156. Thereby, physical changes can be detected in locations that correspond to radio propagation for the wireless propagation channels 151, 152, 153, 154, 155, 156; e.g., locations 141 and 142.

Alternatively or additionally, wireless sensing may be performed by one of the STAs 121, 122, 123, 124, 125, 126 act as sensing transmitter and letting one or more of the other STAs 121, 122, 123, 124, 125, 126 act as sensing receiver. This approach enables detection of changes in the wireless propagation channels between STAs 121, 122, 123, 124, 125, 126, e.g., changes in the wireless propagation channels 161, 162, 163, 164. Thereby, physical changes can be detected in locations that correspond to radio propagation for the wireless propagation channels 161, 162, 163, 164; e.g., locations 142 and 143.

Depending on the deployment, there may still be locations for which physical changes cannot be detected by sensing; e.g., location 144. However, the more possible device combinations there are for sensing transmitter and sensing receiver, the better coverage can typically be provided for the sensing application.

Generally, a sensing system may also comprise a sensing control node. The sensing control node may be configured to cause transmission of sensing packets (e.g., by sending a control signal to the sensing transmitter) and/or to cause sensing measurements (e.g., by sending a control signal to the sensing receiver). The sensing control node may be a separate device, or may be one of the devices that is also acting as sensing transmitter and/or sensing receiver. For example, in the context of FIG. 1, the AP 110 or a STA 121, 122, 123, 124, 125, 126 may be configured as a sensing control node, or the sensing control node may be implemented by a separate control device (CNTR) 130. The separate control device may be deployed in the vicinity of the rest of the sensing system (e.g., within the space 100), or may be located elsewhere. In some embodiments, the separate control device is implemented in a distributed manner; i.e., comprising several control devices which together implement the function of a sensing control node. For example, the sensing control node may be implemented as a cloud service, as illustrated by 135 in FIG. 1.

As already mentioned, a problem in the context of wireless sensing is that the packets used for sensing entail signaling overhead. To this end, some embodiments employ opportunistic sensing, and use dedicated sensing only when sensing measurements obtained by the opportunistic sensing is insufficient for determination of an adequate sensing result. While dedicated sensing comprises transmitting sensing packets specifically for wireless sensing and performing sensing measurements thereon, opportunistic sensing comprises performing sensing measurements on packets transmitted for other purposes than wireless sensing (i.e., packets that would be transmitted even if there was no sensing application). Thereby, the signaling overhead may be reduced.

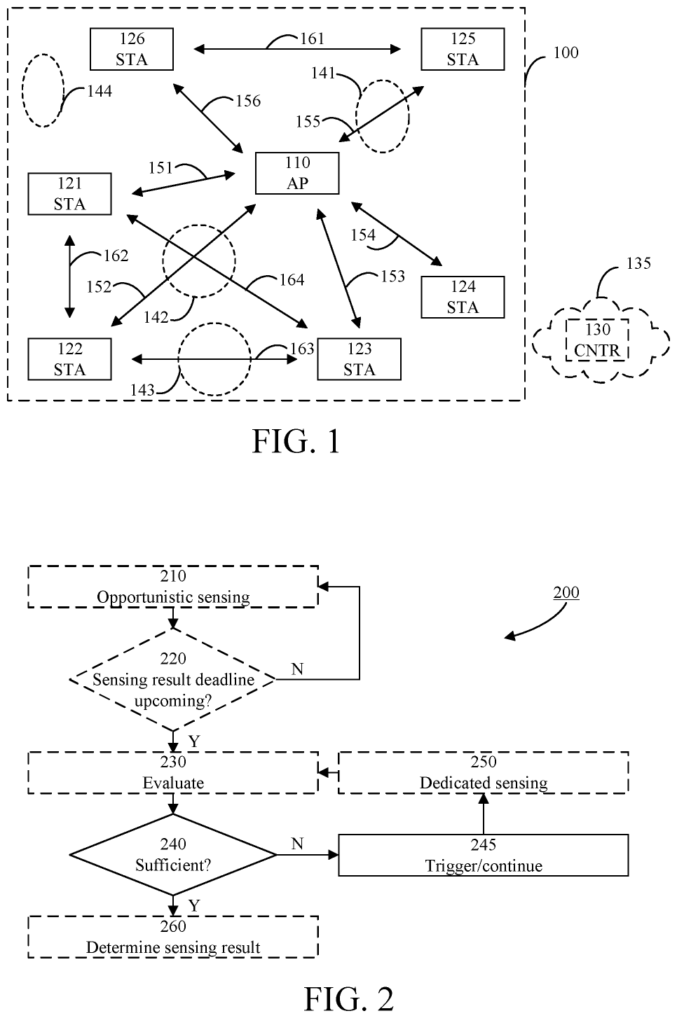

FIG. 2 illustrates an example method 200 for controlling wireless sensing according to some embodiments when opportunistic sensing is available for providing a first set of sensing measurements. For example, the method may be performed by a sensing control node (e.g., by the AP 110 or the separate control device 130 of FIG. 1).

The method 200 comprises triggering a session of dedicated sensing for providing a second set of sensing measurements when the first set of sensing measurements provided by opportunistic sensing is insufficient for determination of a sensing result (as illustrated by step 245 following the N-path of step 240).

In some embodiments, this is implemented by evaluating the first set of sensing measurements provided by opportunistic sensing (as illustrated by optional step 230).

As already mentioned, opportunistic sensing comprises sensing measurements on packets transmitted for other purposes than wireless sensing (e.g., data packets, control packets, or similar), and dedicated sensing comprises sensing measurements on sensing packets transmitted specifically for wireless sensing (denoted herein as sensing packets, for short).

Generally, the first set of sensing measurements provided by opportunistic sensing may be referred to as information pertaining to opportunistic sensing, and the second set of sensing measurements provided by dedicated sensing may be referred to as information pertaining to dedicated sensing.

The activities of performing the opportunistic sensing and/or the dedicated sensing may also be comprised in the method 200 (as illustrated by optional steps 210 and 250, respectively). For example, the device performing the method 200 may also perform sensing measurement (i.e., act as a sensing receiver), or may also transmit data/control packets and/or sensing packet (i.e., act as a sensing transmitter). In some embodiments, the opportunistic sensing and/or the dedicated sensing are not comprised in the method 200. For example, the device performing the method 200 may be a separate control device that receives the sensing information from one or more other devices.

Alternatively or additionally, the determination of a sensing result may also be comprised in the method 200 (as illustrated by optional step 260). For example, the device performing the method 200 may also perform processing of the sensing measurements to detect changes in the wireless propagation channel. In some embodiments, the determination of a sensing result is not comprised in the method 200. For example, the device performing the method 200 may be a separate control device that enable sufficient sensing information to be available for another device to provide adequate sensing by processing of the sensing measurements.

According to the exemplification of FIG. 2, the method 200 starts in step 210 where opportunistic sensing is performed.

The sensing information pertaining to (e.g., obtained by) opportunistic sensing is evaluated to determine whether or not it is sufficient for determination of a sensing result. Typically, the evaluation of the opportunistic sensing information may be performed when a moment in time approaches by which a sensing result is to be provided. This is illustrated by optional step 220, wherein it is determined whether or not a deadline for provision of sensing result is upcoming.

The moment in time by which a sensing result is to be provided may be defined in any suitable way. Typically, the sensing application specifies this moment in time. For example, an intruder detection application may require sensing results to be provided periodically with some predetermined interval.

When the deadline for provision of a sensing result is upcoming (Y-path out of step 220), the method proceeds to step 230 for evaluation of the opportunistic sensing information. When the deadline for provision of a sensing result is not upcoming (N-path out of step 220), the method returns to step 210 and collection of sensing measurements for the first set is continued by performance of opportunistic sensing.

For example, step 220 may comprise determining whether a first moment in time has been reached, which occurs before a second moment in time by which the sensing result is required to be determined (i.e., the second moment in time is the deadline for provision of a sensing result). Then, opportunistic sensing may continue while the first moment in time has not yet been reached (N-path out of step 220), and the evaluation of the opportunistic sensing information may be initiated when the first moment in time has been reached (Y-path out of step 220).

A time interval between the first moment in time and the second moment in time may be configured to accommodate a session of dedicated sensing. For example, the time interval may have a length that allows the evaluation to be made, as well as transmission of a specified number (e.g., one, two, three, or more) of sensing packets and performance of corresponding sensing measurements.

During the evaluation of step 230, it is determined whether or not the sensing information pertaining to opportunistic sensing is sufficient for determination of a sensing result, and step 240 uses the determination to control subsequent processing.

When the sensing information pertaining to opportunistic sensing is determined as sufficient for determination of a sensing result (Y-path out of step 240) the method 200 continues to step 260, where the sensing result is determined based on the opportunistic sensing only.

When the sensing information pertaining to opportunistic sensing is determined as insufficient for determination of a sensing result (N-path out of step 240) the method 200 proceeds to step 245, where a session of dedicated sensing (illustrated by step 250) is triggered. A session of dedicated sensing may, for example, be defined as comprising transmission of at least one sensing packet and collection of corresponding sensing measurements.

Furthermore, the method 100 may comprise performing the session of dedicated sensing by causing transmission of the sensing packet(s) by the sensing transmitter and/or causing corresponding sensing measurements to be performed by sensing receiver(s). For example, causing transmission of the sensing packet(s) may comprise explicitly controlling the sensing transmitter to transmit a sensing packet, or implicitly controlling the sensing transmitter to transmit a sensing packet (e.g., by requesting a buffer status report, BSR, or similar). In some embodiments, one or more sensing receivers may be pre-configured to perform sensing measurements on all available packets, in which case no explicit causing of sensing measurements to be performed is needed.

Triggering of the session of dedicated sensing may be accomplished in any suitable manner. For example, step 245 may comprise transmitting one or more sensing packets, or causing transmission of one or more sensing packets (e.g., by explicit, or implicit, control signaling to a sensing transmitter). An example of implicit control signaling is a request for buffer status report. Alternatively or additionally, step 245 may comprise performing sensing measurements on one or more sensing packets, or causing sensing measurements to be performed on one or more sensing packets (e.g., by explicit, or implicit, control signaling to a sensing receiver).

When there is information available from the session of dedicated sensing (e.g., when sensing measurements have been performed for at least one sensing packet), the method returns to step 230 and sensing information pertaining to the opportunistic sensing combined with the dedicated sensing is evaluated to determine whether or not it is sufficient for determination of a sensing result (e.g., in a similar way as the previous evaluation of sensing information pertaining to only the opportunistic sensing).

When the sensing information pertaining to opportunistic sensing combined with dedicated sensing is determined as sufficient for determination of a sensing result (Y-path out of step 240), the session of dedicated sensing may be terminated and the method 200 continues to step 260, where the sensing result is determined based on a combination of the opportunistic sensing and the dedicated sensing.

Termination of the session of dedicated sensing may be accomplished in any suitable manner. For example, the termination may comprise seizing transmission of further sensing packets, seizing to cause transmission of further sensing packets, or sending explicit control signaling instructing a sensing transmitter to seize transmission of further sensing packets.

When the sensing information pertaining to opportunistic sensing combined with dedicated sensing is determined as insufficient for determination of a sensing result (N-path out of step 240) the method 200 proceeds to step 245, where the session of dedicated sensing (illustrated by step 250) is continued to expand the second set of sensing measurements provided by dedicated sensing.

Continuance of the session of dedicated sensing may be accomplished in any suitable manner. For example, step 245 may comprise transmitting one or more further sensing packets, or causing transmission of one or more further sensing packets (e.g., by explicit, or implicit, control signaling to a sensing transmitter). Alternatively or additionally, step 245 may comprise performing sensing measurements on one or more sensing packets, or causing sensing measurements to be performed on one or more sensing packets (e.g., by explicit, or implicit, control signaling to a sensing receiver).

The loop represented by steps 230, 240, 245, and 250 is typically iterated until the sensing information is determined as sufficient for determination of a sensing result (Y-path out of step 240), or until a stopping criterion is met. Example stopping criteria include that the second moment in time has been reached (in which case it may not be possible to provide the sensing result), and/or that a maximum number (e.g., one, two, three, or more) of sensing packets have been transmitted during the session of dedicated sensing.

It should be noted that many variations exist of the exemplification according to FIG. 2. According to one approach, it is directly known—based on which opportunistic sensing measurements have been acquired in step 210—whether dedicated sensing is needed and/or which sensing transmitter/receiver pairs need to be involved in the dedicated sensing to complement the opportunistic sensing measurements. Then, no specific evaluation step is necessary—especially not to repeatedly evaluate the dedicated sensing—and all necessary dedicated sensing may be performed in one execution of step 250. Hence, the Y-path out of step 220 may proceed directly to step 240, and step 250 may be directly followed by step 260.

Generally, the evaluation in step 230 may comprise any suitable evaluation.

For example, the evaluation may comprise determining whether sensing measurements are available for a number of (data/control and/or sensing) packets, wherein the number exceeds a threshold value for number of packets. When there are sensing measurements available for a number of packets that exceeds the threshold value, it may be determined that the sensing information is sufficient for determination of a sensing result. When there are not sensing measurements available for a number of packets which exceeds the threshold value, it may be determined that the sensing information is insufficient for determination of a sensing result.

Alternatively or additionally, the evaluation may comprise determining whether sensing measurements are available for a pair of (data/control and/or sensing) packets, wherein a time between transmission of the packets of the pair does not exceed a threshold value for time between packets. When there are sensing measurements available for a pair of packets with a time between transmission which is less than the threshold value, it may be determined that the sensing information is sufficient for determination of a sensing result. When there are not sensing measurements available for a pair of packets with a time between transmission which is less than the threshold value, it may be determined that the sensing information is insufficient for determination of a sensing result.

Yet alternatively or additionally, the evaluation may comprise determining whether sensing measurements are available for each required location. When there are sensing measurements available for each required location, it may be determined that the sensing information is sufficient for determination of a sensing result. When there are not sensing measurements available for each required location, it may be determined that the sensing information is insufficient for determination of a sensing result.

Thus, in some embodiments, the sensing result is required to be determined in relation to one or more required locations (compare with locations 141, 142, 143 of FIG. 1).

A required location may be defined as a location for which a sensing result is required. Typically, the sensing application specifies the required locations. For example, an intruder detection application may require sensing results to be provided for one or more locations that each include an entrance to a surveilled space.

Furthermore, each sensing measurement may be seen as associated with a sensed location. For example, referring to FIG. 1, sensing measurements for the wireless propagation channel 155 are associated with the sensed location 141, sensing measurements for the wireless propagation channel 163 are associated with the sensed location 143, and sensing measurements for the wireless propagation channels 152 and 164 are both associated with the sensed location 142.

The sensed location associated with a particular sensing measurement may be defined by a transmitter identity associated with the sensing measurement (i.e., an identity of the transmitter of the packet used for sensing, which may be a data/control packet or a sensing packet). For example, a sensing receiver can derive from the transmitter identity which location(s) are sensed, and associate the corresponding information with the sensing measurement.

Alternatively or additionally, the sensed location associated with a particular sensing measurement may be defined by a beamforming associated with the sensing measurement (e.g., a transmission beam and/or a reception beam of the packet used for sensing, which may be a data/control packet or a sensing packet). For example, a sensing receiver can derive from the suitable reception beam which location(s) are sensed, and associate the corresponding information with the sensing measurement. Alternatively or additionally, a sensing receiver can derive from the intended receiver of a data/control packet which transmission beam was used. Thereby, the sensing receiver can derive which location(s) are sensed, and associate the corresponding information with the sensing measurement.

Yet alternatively or additionally, the sensed location associated with a particular sensing measurement may be defined by a transmission power associated with the sensing measurement. Typically, a high transmission power enables sensing of a relatively large location. For example, a sensing receiver can derive the transmission power from the intended receiver of a data/control packet and knowledge of the deployment (distance between transmitter and intended receiver). Thereby, the sensing receiver can derive which location(s) are sensed, and associate the corresponding information with the sensing measurement.

Information regarding the sensed location may be associated to each sensing measurement for use in the evaluation of sensing information (compare with step 230 of FIG. 2) and/or for use in the determination of sensing result (compare with step 260 of FIG. 2). The information regarding the sensed location may be indicated in the form of one or more of: a location identifier (e.g., location coordinates), a transmitter identity, a receiver identity, a transmission beam identifier (e.g., a beam direction or a beam index), and a transmission power.

According to some embodiments, sensing information is determined as insufficient for determination of a sensing result when—for at least one required location—the required location is comprised in the sensed location for a number of sensing measurements which is lower than a threshold value; and sufficient otherwise.

Any suitable combination of the above examples may also be used in the evaluation step 230.

For example, it may be determined—for each required location—whether sensing measurements are available for a number of pairs of packets, wherein the number exceeds a first threshold value and the time between transmission of the packets of each pair does not exceed a second threshold value. When—for each required location—there are sensing measurements available for a number of pairs of packets with a time between transmission which is less than the second threshold value, where the number of pairs exceeds the first threshold value, it may be determined that the sensing information is sufficient for determination of a sensing result. When—for at least one required location—there are not sensing measurements available for a number of pairs of packets with a time between transmission which is less than the second threshold value, where the number of pairs exceeds the first threshold value, it may be determined that the sensing information is insufficient for determination of a sensing result. The first threshold value may differ between different required locations, or may be the same for different required locations. The second threshold value may differ between different required locations, or may be the same for different required locations.

When the sensing information is determined as insufficient for determination of the sensing result in step 230 (i.e., when the N-path out of step 240 is to be taken), the evaluation may also comprise selecting a sensing transmitter for a next sensing packet to be transmitted specifically for wireless sensing.

For example, if sensing measurements are missing for a required location (e.g., according to any of the example requirements above), the sensing transmitter may be selected such that a sensing packet transmitted by the selected sensing transmitter can provide sensing measurements associated with a sensed location that comprises (or at least overlaps with) the required location. In an example referring to FIG. 1, it is assumed that the AP 110 is performing the method 200, and that sensing measurements are missing for the location 142. Then, the AP 110 can act as sensing transmitter and instruct STA 122 to act as sensing receiver, or the AP 110 can act as sensing receiver and instruct STA 122 to act as sensing transmitter, or the AP 110 can instruct STA 121 as sensing transmitter and instruct STA 123 to act as sensing receiver, or the AP 110 can instruct STA 123 as sensing transmitter and instruct STA 121 to act as sensing receiver.

In some embodiments, when there is a plurality of possible sensing transmitters (e.g., for sensing of a particular required location), the evaluation may comprise determining a score for each of the plurality of possible sensing transmitters, and selecting the sensing transmitter from the plurality of possible sensing transmitters based on the determined scores. For example, the sensing transmitter with the highest score (or lowest score; depending on the score definition) may be selected, or a sensing transmitter with a score that exceeds (or is lower than; depending on the score definition) a threshold value may be selected.

The score may be indicative of a potential increment for the sensing information (e.g., a potential sensing measurement gain associated with further dedicated sensing), if the corresponding sensing transmitter were selected. A potential increment may, for example, relate to how much the probability of detection increases (i.e., how much the probability of missed detection decreases) if the sensing transmitter were to transmit a sensing packet and a corresponding sensing measurement was performed; possibly supplemented by a confidence interval.

One way of implementing the evaluation of the sensing information (step 230) is to use a machine learning model. The machine learning model may be any suitable model, and may be trained in any suitable way. To be suitable, the machine learning model should be configured to determine whether or not sensing information is sufficient for determination of a sensing result. In some embodiments, the machine learning model should also be configured to—if sensing information is determined as not sufficient—select a sensing transmitter for subsequent transmission of a sensing packet.

In some embodiments, the machine learning model could also be configured to perform at least part of the sensing processing (e.g., to detect propagation channel changes based on sensing measurements, and classify corresponding events in relation to a location).

As already mentioned, it should generally be noted that a set of sensing measurements (e.g., the first set of sensing measurements and/or the second set of sensing measurements) may be an empty set, or a set with only one sensing measurement, or a set with two or more sensing measurements. For example, some scenarios may result in that—when step 240 is reached—no sensing measurements have been collected during execution of step 210 (i.e., the first set of sensing measurements is empty), or only one sensing measurement has been collected during execution of step 210 (i.e., the first set of sensing measurements contains only one sensing measurement). Alternatively or additionally, when only a single dedicated sensing packet has been transmitted during the session of dedicated sensing and when sensing measurements have only been performed by a single sensing receiver, the second set of sensing measurements contains only one sensing measurement.

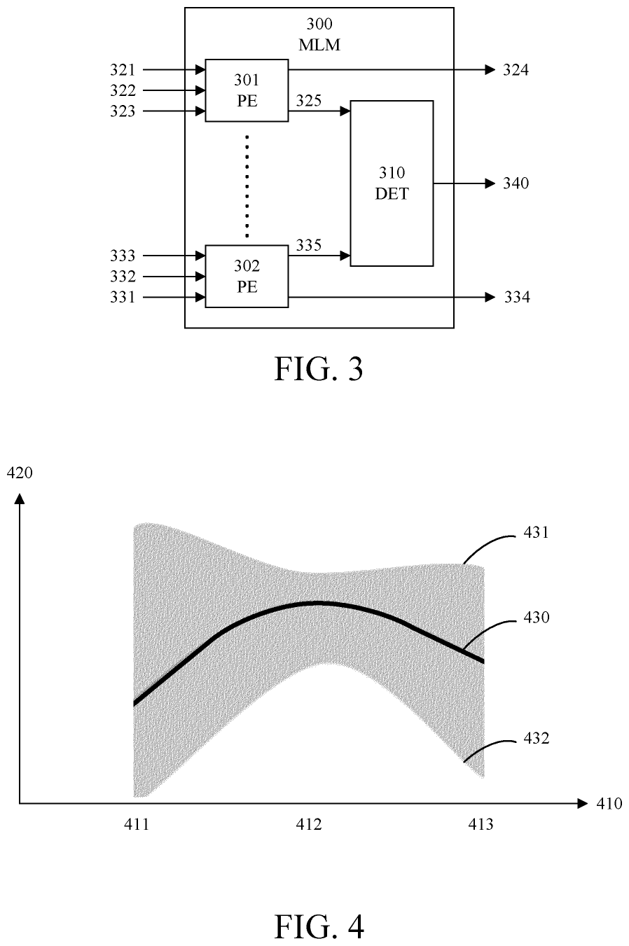

FIG. 3 schematically illustrates an example machine learning model (MLM) 300 according to some embodiments. For example, the MLM 300 may be used to execute step 230 of the method 200 of FIG. 2. In the context of FIGS. 3 and 4, “STA” may refer to non-AP STAs only, or to AP STA as well as non-AP STAs.

The MLM comprises a plurality of probability estimators (PE) 301, 302, wherein each probability estimator is related to a corresponding STA (configured to act as sensing receiver and being a possible sensing transmitter). This is particularly relevant when an AP STA is the sensing control node and only channels between the AP STA and non-AP STAs are measured. More generally, each probability estimators (PE) 301, 302 could be related to a corresponding location.

Furthermore, the illustration in FIG. 3 is particularly relevant when there is a relatively small number of locations, so that each location is conveniently represented by a discrete module (i.e., by a probability estimator 301, 302). More generally, the probability estimation may be merged for two or more locations when there is interdependency between the locations for movement detection, so that two or more locations are represented by the same discrete module (i.e., by the same probability estimator 301, 302). For example, the probability estimation may be merged for all locations, so that all locations are represented by the same discrete module (i.e., by a single probability estimator 301, 302).

For each (data/control or sensing) packet utilized for sensing measurements, the machine learning model 300 receives respective sensing measurement indications 322, 332 (and associated location information 321, 331; e.g., sensed location) for each of one or more STAs. Each sensing measurement indication comprises information regarding the sensing measurements made at the STA for the packet. Typically, the information indicates—for a sensed area—whether or not any sensing measurement was achieved for the packet and/or what the measurement result was.

An output 325, 335 of each probability estimator comprises a probability value (e.g., a current probability of physical movement for each required location), and may also comprise a confidence interval for the probability value.

The output 325, 335 of each probability estimator is provided to a determiner (DET) 310 of the MLM 300.

The determiner 310 uses the output 325, 335 of the probability estimators to determine whether or not sensing information is sufficient for determination of a sensing result, and—if not sufficient—select one of the STAs as sensing transmitter for subsequent transmission of a sensing packet. Thus, the machine learning model selects the sensing transmitter based on the sensing measurement indications. The result of the determination is output at 340, and may comprise an indicator of the selected sensing transmitter (wherein a void may represent that sensing information is sufficient, for example).

In some embodiments, the determination of whether or not sensing information is sufficient for determination of a sensing result is made elsewhere and the determiner 310 uses the output 325, 335 of the probability estimators only to select one of the STAs as sensing transmitter for subsequent transmission of a sensing packet.

In some embodiments, the determiner 310 uses the output 325, 335 of the probability estimators only to determine whether or not sensing information is sufficient for determination of a sensing result, and the selection of sensing transmitter is made elsewhere.

Optionally, the machine learning model may also have a hidden state 323, 324, 333, 334 for each of the one or more STAs, which is updated for each packet utilized for sensing measurements. The representation of the hidden state can be learned during training, for example.

According to some embodiments, a machine learning model may be configured to predict the probability of physical movement for each required location based on a sequence of observations (sensing measurements). This may be accomplished by the probability value of the output 325, 335 of each probability estimator in FIG. 3.

Alternatively or additionally, a machine learning model may be configured to decide whether or not more sensing is needed; and preferably for which location. This may be accomplished by the determiner 310, based on the confidence interval of the output 325, 335 of each probability estimator in FIG. 3.

If—for a particular packet, i.e., a particular time, t—the sensing measurement indications 322, 332 are denoted by oₜ, and the location information 321, 331 is denoted by (x,y), the output 325, 335 may be expressed as pₜ,hₜ=function(x,y,oₜ,hₜ₋₁;θ), where pₜ is a vector of size 2 which denotes the probability value and confidence interval of the output 325, 335, hₜ and hₜ₋₁ is the hidden state at time t and t−1, respectively, and θ represents the weights of the trained model. Generally, pₜ for probability estimator k may be denoted pₖₜ.

Example recurrent models that may be useful in this context include recurrent neural networks, such as long short-term memory (LSTM) networks and dynamic Bayesian networks.

FIG. 4 is a plot illustrating example probability estimates according to some embodiments. The probability estimates of FIG. 4 may be seen as an example of a combination of the outputs 325, 335 of FIG. 3, wherein the STA deployment and the required/sensed locations are represented in one-dimensional space.

The x-axis represents location 410, wherein three STAs are deployed at locations 411, 412, 413, and the y-axis represents probability of physical movement 420. The probability of physical movement, as estimated for different locations by the MLM 300, is shown as 430 and the grey area represents the confidence interval with upper and lower bounds 431, 432.

For example, the plot of FIG. 4 may represent a probability distribution which is based on the output 325, 335 (e.g., achieved by aggregation using a non-parametric model, such as a Gaussian process).

The probability estimates illustrated by FIG. 4 may be used to determine whether or not sensing information is sufficient for determination of a sensing result, and—if not sufficient—select one of the STAs as sensing transmitter for subsequent transmission of a sensing packet. In some embodiments, such determination and selection is performed by the determiner 310 of FIG. 3.

For example, the sensing information may be determined as sufficient for determination of a sensing result when a range between the lower bound 432 and the upper bound 431 of the confidence interval is below a threshold value for all required locations, and—if not sufficient—the STA that corresponds to the largest confidence interval may be selected as sensing transmitter (i.e., the STA at 411 for the example of FIG. 4).

As already mentioned, a score may be determined for each possible sensing transmitter. The score may be used to determine whether or not more dedicated sensing packets should be transmitted and/or which device should act as sensing transmitter.

Thus, in the context of FIGS. 3 and 4, a score may be determined for each STA. The score may, for example, be indicative of what would be gained if a (further) dedicated sensing packet is transmitted to/from the STA (e.g., in terms of changes in upper/lower bound of confidence interval and/or how certain the prediction is).

In the following, a strategy is described for deciding whether a (further) dedicated sensing packet should be sent or not; and which non-AP STA should be involved (together with the AP STA).

The strategy uses the score, the output of the machine learning model, and two parameters λ and N. The parameter λ represents a threshold for minimum score value. If the expected gain is below the threshold, no (further) dedicated sensing packet should be sent. When λ=0, the strategy will always result in sending of a (further) dedicated packet. The parameter N represents the number of dedicated sensing packets that can be sent concurrently. When N=1, the strategy will result in sending a maximum of only one dedicated sensing packet. Then, it would typically wait for measurements to be performed on the sent packet, and a corresponding new prediction from the MLM before taking a new decision.

### Example Dedicated Sensing and STA Selection Policy

Input: an acquisition function ƒ, (p₁ₜ, . . . p_{Kt}), λ, N
Step 1: use (p₁ₜ, . . . p_{Kt}) to construct a non-parametric model G
Step 2: for each STA, compute the score ƒ(STA, G) and sort the STA by score
Step 3: num_sensing_packets=0
Step 3: for a STA in the sorted list, starting with the best score:
Step 4: if the score is smaller than λ, do nothing and exit until a new measurement is received,
   else
Step 5: if the STA is available, send a dedicated sensing packet to (or from) the STA, num_sensing_packets+=1,
Step 6: if num_sensing_packets<N go to next STA (Step 3), else exit

Step 5 checks if the STA under consideration is available. This may be relevant, for example, if some STA(s) might be running tasks which should not be disturbed by dedicated sensing packets. Therefore, step 5 offers the possibility of removing such STA(s) from consideration for dedicated sensing.

Training of the machine learning model exemplified in FIGS. 3 and 4 can be accomplished through supervised learning. For example, training data can be collected using a non-AP STA which is moved around within a space of interest (which includes the locations referred to herein), sharing its position and sending packets that are suitable for sensing. The AP STA could perform sensing measurements on the packets, associate them with the position of the non-AP STA, and use such statistics to train the machine learning model. Alternatively or additionally, simulated statistics may be used for training, as well as information collected during operation (e.g., statistics from executed sessions of dedicated sensing).

Generally, statistics suitable for training the machine learning model may be referred to as labeled data for training.

The training may be performed as offline training. For example, collected labeled data for training may be sent to a database for later training of a machine learning model (e.g., offline training in the cloud). When trained, the machine learning model may be loaded into the sensing control node (e.g., an AP STA).

Alternatively or additionally, the training may be performed as online training. For example, the sensing control node may update the machine learning model automatically. Then the sensing control node could be configured to collect labeled data for training, store it, and use it for training update purposes (e.g., conducted at some regular time interval). The storage and/or training update may take place locally, or in an edge server. To enable collection of labeled data for training, devices (e.g., non-AP STAs) could share their positions with the sensing control node, or the sensing control node could estimate the positions of the devices as part of active sensing.

Yet alternatively or additionally, the training may be performed prior to deployment of the devices comprised in the sensing system (e.g., using more elaborate labeled data for training).

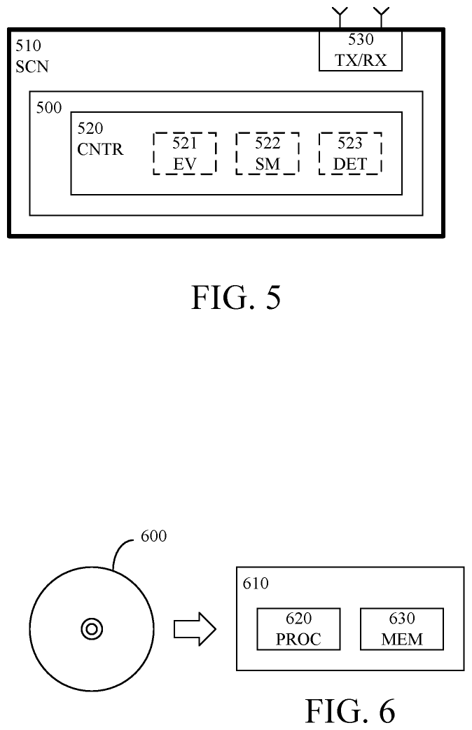

FIG. 5 schematically illustrates an example apparatus 500 according to some embodiments. The apparatus 500 may be comprisable (e.g., comprised) in a sensing control node (SCN) 510, for example, as exemplified in connection with FIG. 1. Alternatively or additionally, the apparatus 500 may be configured to cause execution of (e.g., execute) one or more steps of the method 200 in FIG. 2.

The apparatus 500 is suitable for controlling (e.g., configured to control) wireless sensing when opportunistic sensing is available for providing a first set of sensing measurements, and comprises a controller (CNTR; e.g., controlling circuitry, or a control module) 520.

Furthermore, the apparatus 500 may comprise or be otherwise associated with (e.g., connected, or connectable, to) a transceiver (TX/RX; e.g., transceiving circuitry or a transceiver module) 530. The transceiver 530 may be configured to receive sensing information; for provision to the controller 520. Alternatively or additionally, the transceiver 530 may be configured to transmit sensing packets and/or instructions to a sensing transmitter; as instructed by the controller 520.

The controller 520 is configured to cause triggering (and possibly continuation) of a session of dedicated sensing for providing a second set of sensing measurements responsive to the sensing information being insufficient for determination of a sensing result (compare with steps 240, 245 of FIG. 2). In some embodiments, the controller 520 is also configured to cause termination of the session of dedicated sensing responsive to the sensing information being sufficient for determination of the sensing result.

To this end, the controller 520 may comprise or be otherwise associated with (e.g., connected, or connectable, to) a sensing manager (SM, e.g., managing circuitry or a management module) 522. The sensing manager 522 may be configured to trigger/continue/terminate the session of dedicated sensing.

The controller 520 may also be configured to cause evaluation of sensing information pertaining to opportunistic sensing, and sensing information pertaining to opportunistic sensing combined with dedicated sensing (compare with step 230 of FIG. 2).

To this end, the controller 520 may comprise or be otherwise associated with (e.g., connected, or connectable, to) an evaluator (EV, e.g., evaluating circuitry or an evaluation module) 521. The evaluator 521 may be configured to evaluate sensing information. For example, the evaluator may be implemented using a machine learning model (compare with the MLM 300 of FIG. 3).

The controller 520 may also be configured to—responsive to the sensing information being determined as sufficient for determination of a sensing result—cause determination of the sensing result based on opportunistic sensing only, or on a combination of opportunistic sensing and dedicated sensing (compare with steps 240, 260 of FIG. 2).

To this end, the controller 520 may comprise or be otherwise associated with (e.g., connected, or connectable, to) a determiner (DET, e.g., determining circuitry or a determination module) 523. The determiner 523 may be configured to determine the sensing result.

In some embodiments, the controlling circuitry is also configured to cause selection of a sensing transmitter for a next sensing packet responsive to sensing information being determined as insufficient for determination of the sensing result. The selection may be performed as part of the evaluation of sensing information.

Generally, it should be noted that features and advantages described herein in connection with one of the Figures, may be equally applicable—mutatis mutandis—for one or more of the other Figures; even if not explicitly mentioned in connection thereto.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a sensing control node.

Embodiments may appear within an electronic apparatus (such as a sensing control node) comprising arrangements, circuitry, and/or logic according to any of the embodiments described herein. Alternatively or additionally, an electronic apparatus (such as a sensing control node) may be configured to perform methods according to any of the embodiments described herein.

According to some embodiments, a computer program product comprises a non-transitory computer readable medium such as, for example, a universal serial bus (USB) memory, a plug-in card, an embedded drive, or a read only memory (ROM). FIG. 6 illustrates an example computer readable medium in the form of a compact disc (CD) ROM 600. The computer readable medium has stored thereon a computer program comprising program instructions. The computer program is loadable into a data processor (PROC; e.g., a data processing unit) 620, which may, for example, be comprised in a sensing control node 610. When loaded into the data processor, the computer program may be stored in a memory (MEM) 630 associated with, or comprised in, the data processor. According to some embodiments, the computer program may, when loaded into, and run by, the data processor, cause execution of method steps according to, for example, the method illustrated in FIG. 2, or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1. A method for controlling wireless sensing when opportunistic sensing is available for providing a first set of sensing measurements, the opportunistic sensing comprising sensing measurements on packets transmitted for other purposes than wireless sensing, the method comprising:
when the first set of sensing measurements provided by opportunistic sensing is insufficient for determination of a sensing result, triggering a session of dedicated sensing for providing a second set of sensing measurements, the dedicated sensing comprising sensing measurements on one or more sensing packets transmitted specifically for wireless sensing.

2. The method of claim 1, further comprising determining the sensing result based on a combination of the first set of sensing measurements provided by opportunistic sensing and the second set of sensing measurements provided by dedicated sensing.

3. (canceled)

4. The method of claim 1, further comprising evaluating the first set of sensing measurements provided by opportunistic sensing at a first moment in time, wherein the first moment in time occurs before a second moment in time, and wherein the sensing result is required to be determined at the second moment in time.

5. The method of claim 4, wherein a time interval between the first moment in time and the second moment in time is configured to accommodate the session of dedicated sensing.

6. The method of claim 1, further comprising:
when the first set of sensing measurements provided by opportunistic sensing combined with the second set of sensing measurements provided by dedicated sensing is insufficient for determination of the sensing result, continuing the session of dedicated sensing.

7. The method of claim 6, further comprising, when the first set of sensing measurements provided by opportunistic sensing combined with the second set of sensing measurements provided by dedicated sensing is sufficient for determination of the sensing result, terminating the session of dedicated sensing.

8. The method of claim 1, wherein the sensing result is required to be determined in relation to one or more required locations, wherein each sensing measurement is associated with a sensed location, and wherein sensing measurements are insufficient for determination of the sensing result when, for at least one required location, the required location is comprised in the sensed location for a number of sensing measurements which is lower than a threshold value, wherein the sensed location associated with a particular sensing measurement is defined by a transmitter identity associated with the sensing measurement.

9. (canceled)

10. The method of claim 8, wherein the sensed location associated with a particular sensing measurement is defined by a beamforming associated with the sensing measurement.

11. The method of claim 8, wherein the sensed location associated with a particular sensing measurement is defined by a transmission power associated with the sensing measurement.

12. The method of claim 1, further comprising, when the sensing measurements are insufficient for determination of the sensing result, selecting a sensing transmitter for a next sensing packet to be transmitted specifically for wireless sensing.

13.-19. (canceled)

20. An apparatus for controlling wireless sensing when opportunistic sensing is available for providing a first set of sensing measurements, the opportunistic sensing comprising sensing measurements on packets transmitted for other purposes than wireless sensing, the apparatus comprising controlling circuitry configured to cause:
responsive to the first set of sensing measurements provided by opportunistic sensing being insufficient for determination of a sensing result, triggering of a session of dedicated sensing for providing a second set of sensing measurements, the dedicated sensing comprising sensing measurements on one or more sensing packets transmitted specifically for wireless sensing.

21. The apparatus of claim 20, wherein the controlling circuitry is further configured to cause determination of the sensing result based on a combination of the first set of sensing measurements provided by opportunistic sensing and the second set of sensing measurements provided by dedicated sensing.

22. (canceled)

23. The apparatus of claim 20, wherein the controlling circuitry is further configured to cause evaluation of first set of sensing measurements provided by opportunistic sensing at a first moment in time, wherein the first moment in time occurs before a second moment in time, and wherein the sensing result is required to be determined at the second moment in time.

24. The apparatus of claim 23, wherein a time interval between the first moment in time and the second moment in time is configured to accommodate the session of dedicated sensing.

25. The apparatus of claim 20, wherein the controlling circuitry is further configured to cause:
responsive to the first set of sensing measurements provided by opportunistic sensing combined with the second set of sensing measurements provided by dedicated sensing being insufficient for determination of the sensing result, continuation of the session of dedicated sensing.

26. The apparatus of claim 25, wherein the controlling circuitry is further configured to cause, responsive to the first set of sensing measurements provided by opportunistic sensing combined with the second set of sensing measurements provided by dedicated sensing being sufficient for determination of the sensing result, termination of the session of dedicated sensing.

27. The apparatus of claim 20, wherein the sensing result is required to be determined in relation to one or more required locations, wherein each sensing measurement is associated with a sensed location, and wherein sensing measurements are insufficient for determination of the sensing result when, for at least one required location, the required location is comprised in the sensed location for a number of sensing measurements which is lower than a threshold value, wherein the sensed location associated with a particular sensing measurement is defined by a transmitter identity associated with the sensing measurement.

28. (canceled)

29. The apparatus of claim 27, wherein the sensed location associated with a particular sensing measurement is defined by a beamforming associated with the sensing measurement.

30. The apparatus of claim 27, wherein the sensed location associated with a particular sensing measurement is defined by a transmission power associated with the sensing measurement.

31. The apparatus of claim 20, wherein the controlling circuitry is further configured to cause, responsive to sensing measurements being insufficient for determination of the sensing result, selection of a sensing transmitter for a next sensing packet to be transmitted specifically for wireless sensing.

32.-38. (canceled)
